(19) United States
(12) Patent Application Publication
(10) Pub. No.: US 2025/0123726 A1
(43) Pub. Date: Apr. 17, 2025

(54) METHOD AND DEVICE FOR SUMMARIZING EVENT OCCURRING FOR APPLICATION

(71) Applicant: Samsung Electronics Co., Ltd., Suwon-si (KR)

(72) Inventors: Dongil SON, Suwon-si (KR); Dukhyun KIM, Suwon-si (KR); Sangheon KIM, Suwon-si (KR); Junsung KIM, Suwon-si (KR); Yoechan SONG, Suwon-si (KR); Yeunwook LIM, Suwon-si (KR)

(21) Appl. No.: 18/781,620

(22) Filed: Jul. 23, 2024

Related U.S. Application Data
(63) Continuation of application No. PCT/KR2024/008344, filed on Jun. 17, 2024.

(30) Foreign Application Priority Data
Oct. 11, 2023 (KR) 10-2023-0135457
Nov. 22, 2023 (KR) 10-2023-0163703

(51) Int. Cl. G06F 3/0482; G06F 40/169

(52) U.S. Cl. CPC G06F 3/0482; G06F 40/169

(57) ABSTRACT

An electronic device includes: a display, at least one processor, comprising processing circuitry, and a memory configured to store instructions, wherein the instructions when executed by the at least one processor, individually and/or collectively, cause the electronic device to: based on a first input of a user being obtained for an application, attempt to look up events accumulated in an event list for events that are not checked by the user for the application, based on events being looked up in the event list, generate summary information summarizing the looked-up events from the event information of the looked-up events, and, display a graphic object corresponding to the generated summary information in a region of the display corresponding to the application.

### CROSS-REFERENCE TO RELATED APPLICATIONS

This application is a continuation application of International Application No. PCT/KR2024/008344 designating the United States, filed on Jun. 17, 2024, in the Korean Intellectual Property Receiving Office and claiming priority to Korean Patent Application No. 10-2023-0135457, filed on Oct. 11, 2023, and Korean Patent Application No. 10-2023-0163703, filed on Nov. 22, 2023, in the Korean Intellectual Property Office, the disclosures of each of which are incorporated by reference herein in their entireties.

### BACKGROUND

### 1. Field

The disclosure relates to a method of summarizing events occurring for applications.

### 2. Description of Related Art

In a method of an electronic device providing a notification, when an event, the notification of which should be provided to a user, occurs in each application installed in the electronic device, an application (or a server corresponding to the application) may transmit the event information of the event to a framework module of the electronic device, and the electronic device may determine whether to provide the notification of the event. When determining to provide the notification of the event, the electronic device may notify the user of the occurrence of the event through a notification object. When the user's input to the notification (or the notification object) is not detected during a predetermined time, the electronic device may insert the notification into a notification management window (e.g., a notification bar) or may display a graphic object (e.g., a badge object) indicating the occurrence of the event on an icon of the application. For example, the electronic device may display the badge object corresponding to the number of events accumulated for the application by overlaying the badge object on the icon of the application.

### SUMMARY

According to an example embodiment, an electronic device may include: a display; at least one processor, comprising processing circuitry; and a memory configured to store instructions, when executed by at least one processor, individually and/or collectively, cause the electronic device to: based on a first input of a user being obtained for an application, attempt to look up events accumulated in an event list for events that are not checked by the user for the application, based on events being looked up in the event list, generate summary information summarizing the looked-up events from the event information of the looked-up events, and, display a graphic object corresponding to the generated summary information in a region of the display corresponding to the application.

According to an example embodiment a method may comprise: based on a first input of a user being obtained for an application, attempting to look up events accumulated in an event list for events that are not checked by the user for the application; based on events being looked up in the event list, generating summary information summarizing the looked-up events from the event information of the looked-up events; and, displaying a graphic object corresponding to the generated summary information in a region corresponding to the application.

### BRIEF DESCRIPTION OF THE DRAWINGS

The above and other aspects, features, and advantages of certain embodiments of the present disclosure will be more apparent from the following detailed description, taken in conjunction with the accompanying drawings, in which:

FIG. 1 is a block diagram illustrating an example electronic device in a network environment according to various embodiments;

FIG. 2 is a flowchart illustrating an example method of operating an electronic device providing the summary of events accumulated for an application, according to various embodiments;

FIG. 3 is a flowchart illustrating an example method of operating an electronic device generating summary information according to a summary form, according to various embodiments;

FIG. 4 is a block diagram illustrating an example configuration of an electronic device according to various embodiments;

FIG. 5A is a flowchart illustrating an example operation of an electronic device determining a summary level based on information on a screen, according to various embodiments;

FIG. 5B is a diagram illustrating an example operation of obtaining a second input that designates a summary level when an electronic device obtains a first input through a notification management screen, according to various embodiments;

FIG. 5C is a diagram illustrating an example operation of an electronic device generating summary information based on a summary level, according to various embodiments;

FIGS. 6A and 6B are diagrams, each illustrating an example operation of an electronic device determining a summary level based on an available region of a display, according to various embodiments;

FIGS. 7A, 7B, and 7C are diagrams each illustrating an example operation of an electronic device generating summary information based on a plurality of summary forms, according to various embodiments; and

FIGS. 8A, 8B, and 8C are diagrams each illustrating an example operation of an electronic device displaying a screen based on whether an event is looked up, according to various embodiments.

### DETAILED DESCRIPTION

Hereinafter, various example embodiments will be described in greater detail with reference to the accompanying drawings. When describing the various embodiments with reference to the accompanying drawings, like reference numerals refer to like elements and a repeated description related thereto will be omitted.

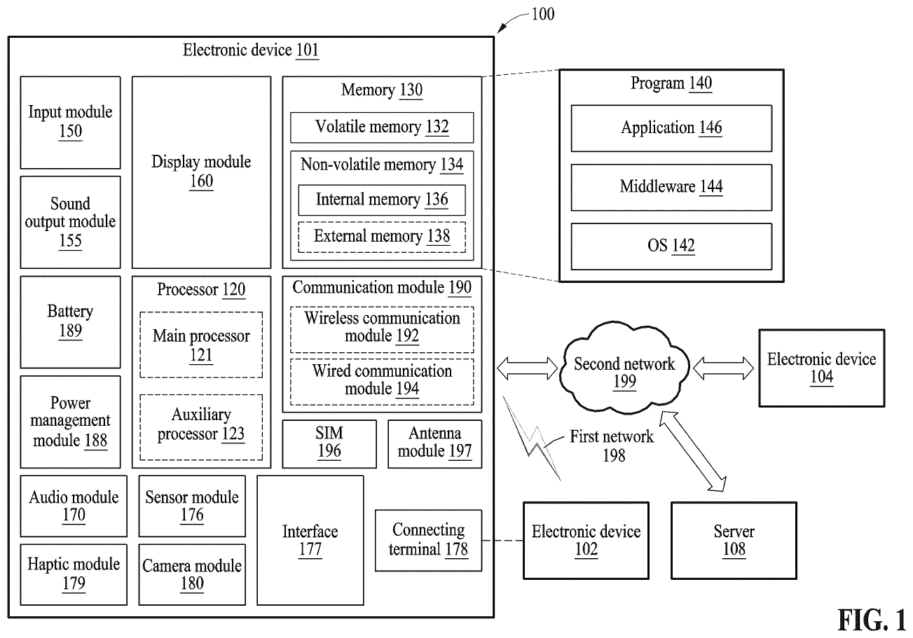

FIG. 1 is a block diagram illustrating an example electronic device in a network environment according to various embodiments.

Referring to FIG. 1, an electronic device 101 in a network environment 100 may communicate with an electronic device 102 via a first network 198 (e.g., a short-range wireless communication network), or communicate with at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, a memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In various embodiments, at least one (e.g., the connecting terminal 178) of the above components may be omitted from the electronic device 101, or one or more other components may be added in the electronic device 101. In various embodiments, some (e.g., the sensor module 176, the camera module 180, or the antenna module 197) of the components may be integrated as a single component (e.g., the display module 160).

The processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. The processor 120 may execute, for example, software (e.g., a program 140) to control at least one other component (e.g., a hardware or software component) of the electronic device 101 connected to the processor 120 and may perform various data processing or computation. According to an embodiment, as at least a part of data processing or computation, the processor 120 may store a command or data received from another component (e.g., the sensor module 176 or the communication module 190) in a volatile memory 132, process the command or the data stored in the volatile memory 132, and store resulting data in a non-volatile memory 134. According to an embodiment, the processor 120 may include a main processor 121 (e.g., a central processing unit (CPU) or an application processor (AP)) or an auxiliary processor 123 (e.g., a graphics processing unit (GPU), a neural processing unit (NPU), an image signal processor (ISP), a sensor hub processor, or a communication processor (CP)) that is operable independently from, or in conjunction with the main processor 121. For example, when the electronic device 101 includes the main processor 121 and the auxiliary processor 123, the auxiliary processor 123 may be adapted to consume less power than the main processor 121 or to be specific to a specified function. The auxiliary processor 123 may be implemented as separate from, or as part of the main processor 121.

The auxiliary processor 123 may control at least some of functions or states related to at least one (e.g., the display module 160, the sensor module 176, or the communication module 190) of the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an ISP or a CP) may be implemented as part of another component (e.g., the camera module 180 or the communication module 190) functionally related to the auxiliary processor 123. According to an embodiment, the auxiliary processor 123 (e.g., an NPU) may include a hardware structure specified for artificial intelligence model processing. An artificial intelligence model may be generated through machine learning. Such learning may be performed, for example, by the electronic device 101 in which an artificial intelligence model is executed, or via a separate server (e.g., the server 108). Learning algorithms may include, but are not limited to, for example, supervised learning, unsupervised learning, semi-supervised learning, or reinforcement learning. The artificial intelligence model may include a plurality of artificial neural network layers. An artificial neural network may include, for example, a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network, or a combination of two or more thereof, but is not limited thereto. The artificial intelligence model may additionally or alternatively include a software structure other than the hardware structure.

The memory 130 may store various pieces of data used by at least one component (e.g., the processor 120 or the sensor module 176) of the electronic device 101. The various pieces of data may include, for example, software (e.g., the program 140) and input data or output data for a command related thereto. The memory 130 may include the volatile memory 132 or the non-volatile memory 134.

The program 140 may be stored as software in the memory 130 and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output a sound signal to the outside of the electronic device 101. The sound output module 155 may include, for example, a speaker or a receiver. The speaker may be used for general purposes, such as playing multimedia or playing record. The receiver may be used to receive an incoming call. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to sense a touch, or a pressure sensor adapted to measure the intensity of force incurred by the touch.

The audio module 170 may convert a sound into an electrical signal and vice versa. According to an embodiment, the audio module 170 may obtain the sound via the input module 150 or output the sound via the sound output module 155 or an external electronic device (e.g., the electronic device 102 such as a speaker or headphones) directly or wirelessly connected to the electronic device 101.

The sensor module 176 may detect an operational state (e.g., power or temperature) of the electronic device 101 or an environmental state (e.g., a state of a user) external to the electronic device 101, and generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., by wire) or wirelessly. According to an embodiment, the interface 177 may include, for example, a high-definition multimedia interface (HDMI), a universal serial bus (USB) interface, a secure digital (SD) card interface, or an audio interface.

The connecting terminal 178 may include a connector via which the electronic device 101 may be physically connected to the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or an electrical stimulus which may be recognized by a user via his or her tactile sensation or kinesthetic sensation. According to an embodiment, the haptic module 179 may include, for example, a motor, a piezoelectric element, or an electric stimulator.

The camera module 180 may capture a still image and moving images. According to an embodiment, the camera module 180 may include one or more lenses, image sensors, ISPs, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more CPs that are operable independently of the processor 120 (e.g., an AP) and that support a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module, or a power line communication (PLC) module). A corresponding one of these communication modules may communicate with the external electronic device 104 via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., a LAN or a wide area network (WAN)). These various types of communication modules may be implemented as a single component (e.g., a single chip), or may be implemented as multiple components (e.g., multiple chips) separate from each other. The wireless communication module 192 may identify and authenticate the electronic device 101 in a communication network, such as the first network 198 or the second network 199, using subscriber information (e.g., international mobile subscriber identity (IMSI)) stored in the SIM 196.

The wireless communication module 192 may support a 5G network after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., a mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), an array antenna, analog beamforming, or a large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., an external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in a communication network, such as the first network 198 or the second network 199, may be selected by, for example, the communication module 190 from the plurality of antennas. The signal or power may be transmitted or received between the communication module 190 and the external electronic device via the at least one selected antenna. According to an embodiment, another component (e.g., a radio frequency integrated circuit (RFIC)) other than the radiating element may be additionally formed as part of the antenna module 197.

According to an embodiment, the antenna module 197 may form a mmWave antenna module. According to an embodiment, the mmWave antenna module may include a PCB, an RFIC disposed on a first surface (e.g., the bottom surface) of the PCB or adjacent to the first surface and capable of supporting a designated high-frequency band (e.g., the mmWave band), and a plurality of antennas (e.g., array antennas) disposed on a second surface (e.g., the top or a side surface) of the PCB, or adjacent to the second surface and capable of transmitting or receiving signals in the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the external electronic devices 102 and 104 may be a device of the same type as or a different type from the electronic device 101. According to an embodiment, all or some of operations to be executed at the electronic device 101 may be executed at one or more of external electronic devices (e.g., the external electronic devices 102 and 104, or the server 108). For example, if the electronic device 101 needs to perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or MEC. In an embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., a smart home, a smart city, a smart car, or healthcare) based on 5G communication technology or IoT-related technology.

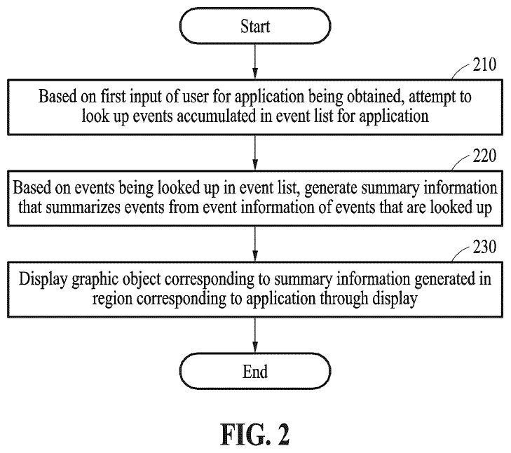

FIG. 2 is a flowchart illustrating an example method of operating an electronic device providing the summary of events accumulated for an application, according to various embodiments.

The electronic device (e.g., the electronic device 101 of FIG. 1), according to an embodiment, may provide the summary of events accumulated for an application (e.g., the application 146 of FIG. 1).

In operation 210, the electronic device, based on a first input of a user to the application being obtained, may attempt to look up the events (e.g., events that are not checked by the user after the events have occurred) accumulated in an event list for the application. The event list may include an event list of the events that are not checked by the user.

The application is software installed in the electronic device and may provide the electronic device (or the user of the electronic device) with a service provided by a server corresponding to the application.

An event may include, for example, a change of service information for the electronic device in a service used by the electronic device. For example, the change of service information may include a change of an item provided by the service. For example, as to a message service, the event may include a new message transmitted to the electronic device. As to a mail service, the event may include a new mail transmitted to the electronic device. As to a banking service, the event may include at least one of the deposit to an account corresponding to the electronic device, the withdrawal from the account corresponding to the electronic device, the maturity of the account corresponding to the electronic device, or the opening of the account corresponding to the electronic device. As to a card service, the event may include at least one of the payment through a card corresponding to the electronic device or the expiration of the card corresponding to the electronic device. For example, the change of service information may include a change of advertising information (e.g., addition, deletion, or update) related to the service.

In various embodiments of the present disclosure, an event for an application may refer to data corresponding to the event transmitted to an electronic device through the application. The data transmitted through the application may refer to the data transmitted to the electronic device from a server corresponding to the application.

The event list may include the event for the application. The event list may correspond to the application and/or the server corresponding to the application. The event list may include the events that are not checked by the user among events having occurred for the application. In various embodiments of the present disclosure, an event that is not checked by a user after having occurred may also be referred to as an accumulated event.

According to an embodiment, the electronic device may receive an event from the server, based on the occurrence of the event for the application installed in the electronic device. The electronic device may insert the event into the event list (e.g., an event list corresponding to the application). Based on the user's checking of the event, the electronic device may delete the checked event from the event list.

The event information may include, for example, the occurrence time of an event, the substance of the event, or the properties of the event.

For example, the event information of a message reception event of the message service may include a reception time of a message, a sender identifier of the message, or the content (e.g., at least one of text, image, or video) included in the message.

For example, the event information of a mail reception event of the mail service may include a reception time of a mail, a sender identifier of the mail, a receiver identifier of the mail, a carbon copy (CC) receiver identifier of the mail, the title of the mail, the content (e.g., at least one of text, image, or video) included in the mail, or the information on an attached file of the mail.

For example, the event information of a deposit or withdrawal event of the banking service may include the time of deposit or withdrawal, the amount of deposit or withdrawal, the stated text on the account, or the balance of the account. The event information of an account maturity event of the banking service may include account balance, account maturity date, principal, interest, or the information of other recommended accounts. The event information of an account opening event of the banking service may include opening date or expiration date.

The first input of the user may refer to an input for requesting the summary of an event designated by the first input.

According to an embodiment, the first input may designate an application. When the first input designates an application, the electronic device may generate summary information that summarizes events accumulated for the application. For example, the electronic device may obtain the first input that designates an application when detecting a continuous input (e.g., a long-press input) of the user during a threshold time (e.g., 1 second) to an icon of the application. For example, the first input may include an input to a graphic object (e.g., an icon object) corresponding to an application on a home screen. For example, the electronic device may obtain the first input that designates a plurality of applications included in a folder when detecting the continuous input (e.g., the long-press input) of the user during the threshold time (e.g., 1 second) to an icon of the folder including the plurality of applications.

In various embodiments of the present disclosure, the first input may be described as designating one application or a plurality of applications, but examples are not limited thereto.

For example, the first input may designate a notification management window (e.g., a notification bar). The notification management window may include a notification on an event based on event information received from the server. The notification management window may include notifications on a plurality of applications installed in the electronic device. The electronic device may delete a notification corresponding to a delete input from the notification management window when obtaining the delete input of the user for each notification. The electronic device may delete a notification from the notification management window when the user checks an event corresponding to the notification. When the first input designates the notification management window, the electronic device may generate summary information that summarizes events corresponding to notifications included in the notification management window. The electronic device may display the generated summary information in a region corresponding to the notification management window.

For another example, the first input may designate a notification included in the notification management window. When the first input designates the notification, the electronic device may generate summary information that summarizes an event corresponding to the notification. The electronic device may display the generated summary information in a region corresponding to the notification designated by the first input.

In operation 220, based on events being looked up in the event list, the electronic device may generate summary information that summarizes the looked-up events from the event information of the looked-up events.

The summary information may include text that summarizes an event. When the event list includes a plurality of events, the summary information may include text that summarizes the plurality of events.

For example, the summary information of the message reception event of the message service may include text corresponding to the topic of conversation corresponding to a new message (e.g., an accumulated event) that is not checked by the user.

For example, the summary information of the mail reception event of the mail service may include text describing a file (e.g., document, image, or video) attached to the mail or the topic of the mail.

The electronic device, according to an embodiment, may determine a summary level. The electronic device may generate summary information based on the summary level.

The summary level may include the degree of brevity (or the degree of detail) of summary information that summarizes an event. The summary level may be determined to be one of a plurality of candidate levels (e.g., a first level or a second level that is higher than the first level). According to an embodiment, a higher summary level may correspond to less brief summary information (e.g., more detailed summary information). According to an embodiment, each candidate level may have a limit on an amount.

For example, the summary information of the first level may be limited such that partial text included in the summary information may include the number of words that is less than or equal to a first word count. The summary information of the second level may be limited such that partial text included in the summary information may include the number of words that is less than or equal to a second word count, which is greater than the first word count.

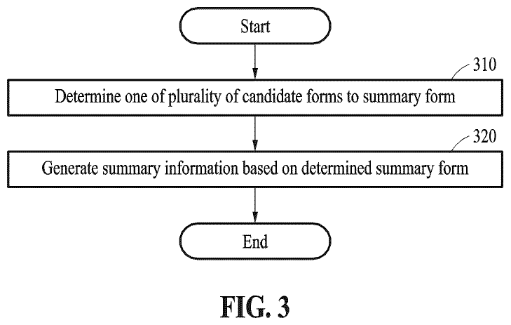

The partial text may include at least a portion of text included in summary information and may refer to text that summarizes one or more events. As described in more detail below with reference to FIG. 3, each partial text of summary information may summarize one event, an event group, and/or events of one application, depending on a summary form.

The event group may refer to a set of events that are in common. For example, the event group may include events corresponding to messages received through the same chatroom in the message service. The event group may include events corresponding to messages received through chatrooms of the same chatroom type (e.g., a one-to-one chatroom, a group chatroom, or an anonymous chatroom).

For example, the event group may include events corresponding to mails belonging to the same thread in the mail service. If a second mail is written as a reply to and/or the forwarding of a first mail, the first mail and the second mail may belong to the same thread. If the first mail and the second mail are written as a reply to and/or the forwarding of the same mail, the first mail and the second mail may belong to the same thread.

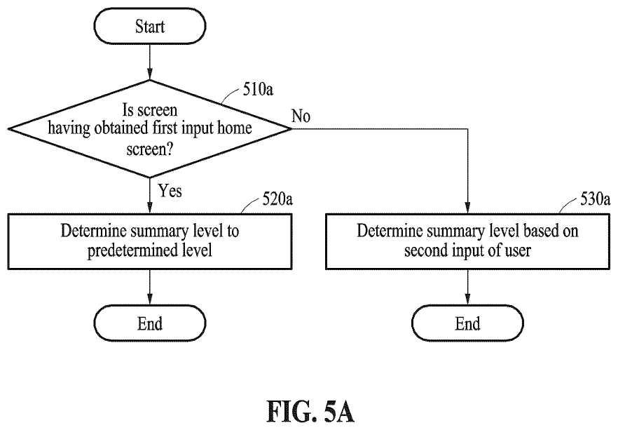

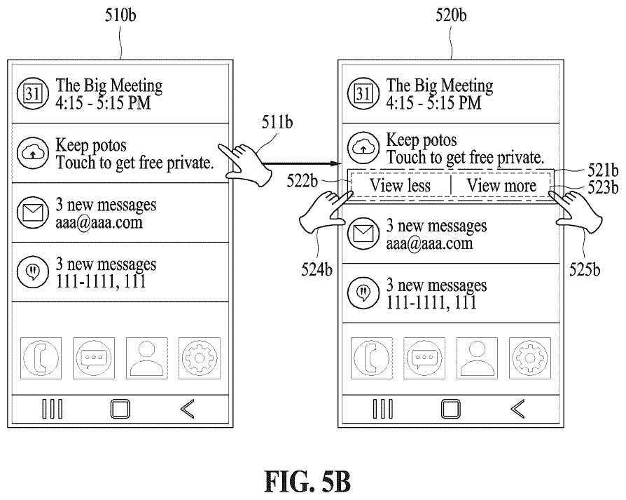

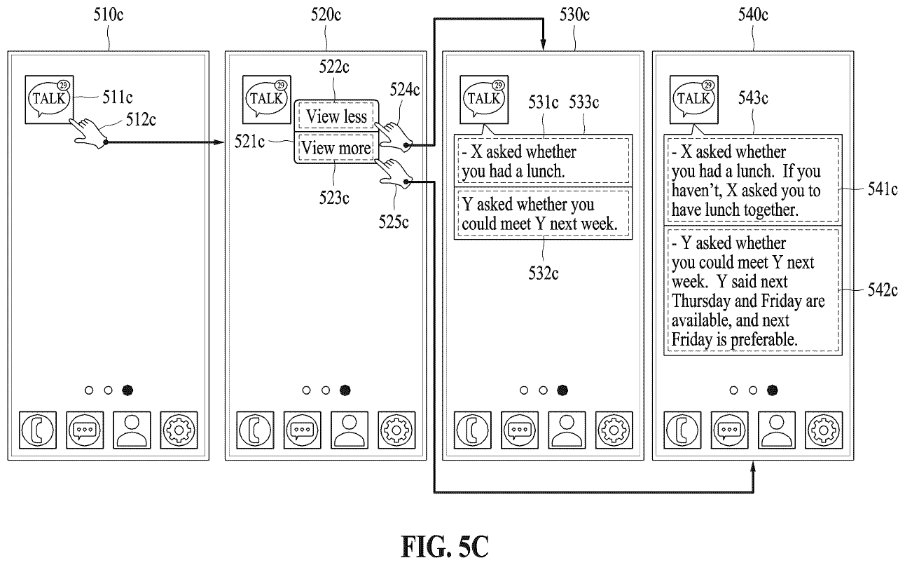

According to an embodiment, the electronic device may determine the summary level based on information on a screen where the first input of the user is obtained. The electronic device may determine the summary level to a predetermined level based on the screen (e.g., the home screen, an application list screen, or a notification management screen) where the first input is obtained. The operation of determining the summary level based on the screen where the first input is obtained is described in greater detail below with reference to FIGS. 5A and 5B.

According to an embodiment, the electronic device may determine the summary level based on the second input of the user. The operation of the electronic device obtaining the second input that designates the summary level is described in greater detail below with reference to FIGS. 5B and 5C.

In operation 230, the electronic device may display a graphic object corresponding to the summary information generated in a region corresponding to the application through a display (e.g., the display module 160 of FIG. 1). In various embodiments of the present disclosure, a graphic object corresponding to summary information may also be referred to as a summary object.

The electronic device, according to an embodiment, may limit the execution of the application while performing the attempting of looking up events, the determining of the summary level, the generating of summary information, and the displaying of the graphic object. When obtaining the first input that requests the summary of events accumulated for the application, the electronic device may generate the summary information that summarizes the events using event information without executing the application. The electronic device may generate the event information without executing the application.

According to an embodiment, the electronic device may provide the summary of events accumulated for a plurality of applications. Based on the first input being input to the plurality of applications, the electronic device may obtain event lists respectively for the plurality of applications. For example, the electronic device may obtain the first input to an icon of a folder including the plurality of applications. The first input may be an input to the plurality of applications included in the folder. Based on events being looked up in at least one event list of the plurality of event lists respectively for the plurality of applications, the electronic device may determine the summary level. The electronic device may generate the summary information that summarizes the looked-up events in the plurality of event lists.

FIG. 3 is a flowchart illustrating an example method of operating an electronic device generating summary information according to a summary form, according to various embodiments.

The electronic device (e.g., the electronic device 101 of FIG. 1), according to an embodiment, may determine a summary form and may generate summary information based on the summary form.

In operation 310, the electronic device may determine at least one of a plurality of candidate forms to be the summary form. The summary form may be a reference for determining an event to be used to generate each partial text of the summary information. For example, the plurality of candidate forms may include summarizing by events, summarizing by groups, each including events that are in common, or summarizing by applications.

According to an embodiment, the electronic device may obtain a third input, which designates one candidate form of the plurality of candidate forms of a user. The electronic device may determine the candidate form designated by the third input to the summary form. The electronic device may display a graphic object for designating a summary form. The graphic object for designating a summary form may include a plurality of regions respectively corresponding to the plurality of candidate forms. When detecting the third input of the user in one region of the plurality of regions, the electronic device may determine a candidate form corresponding to the region where the third input is detected to be the summary form.

According to an embodiment, the electronic device may determine the summary form based on the properties of an event that is looked up in an event list.

The properties of an event may refer to the features of the event. The properties of an event may be included in the event information. For example, the properties of an event may include whether the event is related to advertisement and/or spam. For example, the properties of an event may include the type (e.g., a one-to-one chatroom, a group chatroom, or an anonymous chatroom) of chatroom where a message is received when the event is a message reception event of a message service. For example, the properties of an event may include a status (e.g., a receiver (also referred to as ‘TO’), a CC receiver, or a blind CC (BCC) receiver) of a person who receives a mail when the event is a mail reception event of a mail service. For example, the properties of an event may include the type (e.g., a payment event or an advertising event) of the event when the event is an event of a card service.

When looking up a plurality of events in the event list, the electronic device may determine the summary form that summarizes the events according to the respective properties of the events. The electronic device may summarize some events of the plurality of events in a first summary form and may summarize the other events of the plurality of events in a second summary form.

For example, the electronic device may look up the plurality of events in the event list. The electronic device may determine the first summary form for summarizing events having first properties to be a first candidate form, based on the properties of events. The electronic device may determine the second summary form for summarizing events having second properties to be a second candidate form, based on the properties of events.

For example, as to the message reception event of the message service, the electronic device may determine the summary form according to the type of chatroom where a message is received. If an event is the message reception event of a message received through a one-to-one chatroom, the electronic device may determine the summary form to summarize an event group corresponding to messages received through the same chatroom. If an event is the message reception event of a message received through an anonymous chatroom, the electronic device may determine the summary form to summarize an event group corresponding to messages received through the same type (e.g., the anonymous chatroom) of chatrooms.

For example, as to the mail reception event of the mail service, the electronic device may determine the summary form according to the status of a person who receives mail. If an event is the mail reception event of mail received by a receiver, the electronic device may determine the summary form to be summarizing by events. If an event is the mail reception event of mail received by a CC receiver, the electronic device may determine the summary form to be summarizing by event groups each including a mail reception event belonging to the same thread.

According to an embodiment, when a first input of the user is an input to a plurality of applications, the electronic device may determine the summary form to be summarizing by applications.

In operation 320, the electronic device may generate the summary information based on the determined summary form.

For example, when the summary form is summarizing by events, each partial text may correspond to one event. The electronic device may generate one partial text using the event information of one event.

For another example, when the summary form is summarizing by event groups, each partial text may correspond to one event group. The electronic device may generate one partial text using the event information of events included in one event group.

In yet another example, when the summary form is summarizing by applications, each partial text may correspond to one application. As described above with reference to FIG. 2, the first input of the user may designate the plurality of applications. The electronic device may generate one partial text based on the event information of at least one event for one application of the plurality of applications.

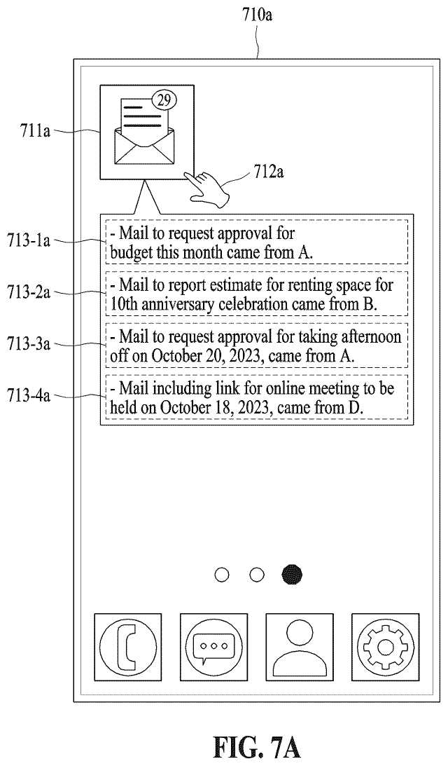

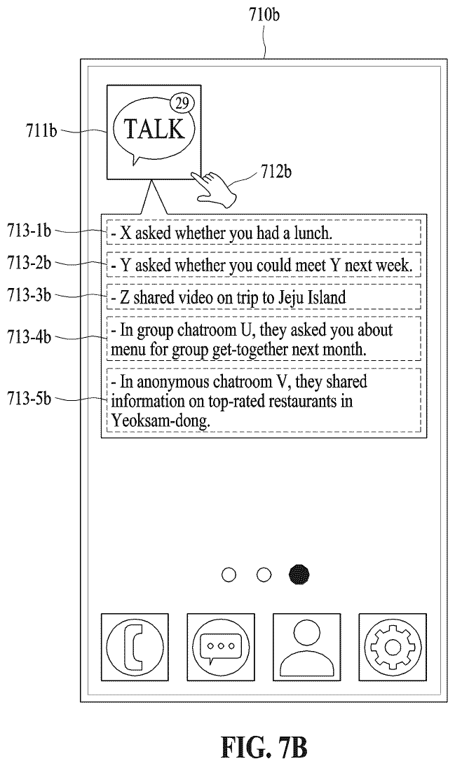

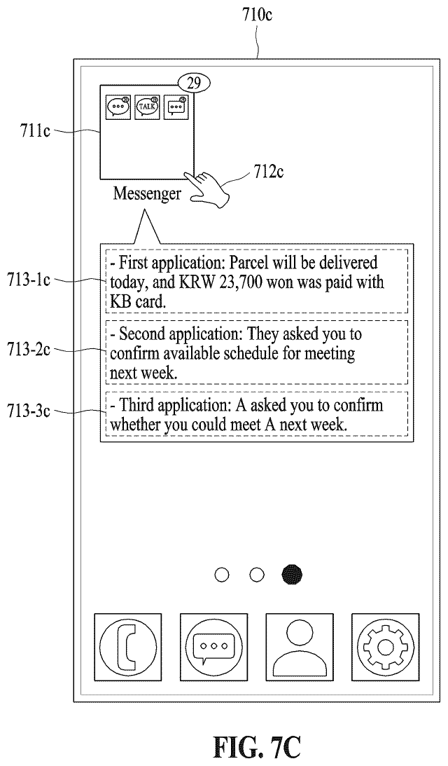

The example of the summary information according to the summary form is described in more greater below with reference to FIGS. 7A, 7B and 7C.

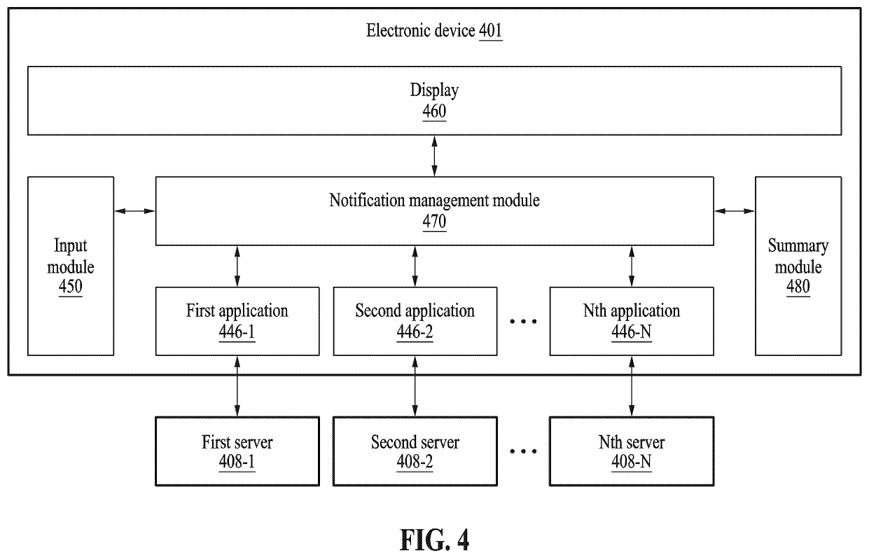

FIG. 4 is a block diagram illustrating an example configuration of an electronic device according to various embodiments.

According to an embodiment, an electronic device 401 (e.g., the electronic device 101 of FIG. 1) may include an input module (e.g., including input circuitry) 450 (e.g., the input module 150 of FIG. 1), a display 460 (e.g., the display module 160 of FIG. 1), a notification management module (e.g., including various circuitry and/or executable program instructions) 470, and a summary module (e.g., including various circuitry and/or executable program instructions) 480. The electronic device 401 may include a memory (not shown) (e.g., the memory 130 of FIG. 1), and the memory of the electronic device 401 may store a plurality of applications (e.g., a first application 446-1, a second application 446-2, . . . , an Nth application 446-N).

According to an embodiment, the plurality of applications may respectively correspond to a plurality of servers (e.g., a first server 408-1, a second server 408-2, . . . , an Nth server 408-N). For example, referring to FIG. 4, the first application 446-1 may correspond to the first server 408-1, the second application 446-2 may correspond to the second server 408-2, and the Nth application 446-N may correspond to the Nth server 408-N. Each application may provide the electronic device 401 with a service provided by a corresponding server. Each server may transmit event information to an application of the electronic device 401, based on an event occurring in a service provided by a corresponding server.

The input module 450, according to an embodiment, may include various input circuitry and specify an application corresponding to a user's input when obtaining (e.g., detecting) the user's input. For example, the input module 450 may specify an application designated by the user's input.

The notification management module 470, according to an embodiment, may include various circuitry and/or executable program instructions and manage an event notification for applications (e.g., the first application 446-1, the second application 446-2, . . . , the Nth application 446-N) installed in the electronic device 401. For example, the notification management module 470 may log (e.g., record logs for notifications) notifications in the applications installed in the electronic device 401. The logs for notifications may include event information corresponding to the notifications. The notification management module 470 may transmit a log and/or event information for a notification to the summary module 480 when generating summary information for an event.

The summary module 480, according to an embodiment, may include various circuitry and/or executable program instructions and receive the log and/or event information for a notification from the notification management module 470. The summary module 480 may generate summary information that summarizes an event based on the received log and/or event information for a notification. The summary module 480 may transmit the generated summary information to the notification management module 470.

Although the summary module 480 is mainly described, with reference to FIG. 4, as included in the electronic device 401, examples are not limited thereto. According to an embodiment, the summary module 480 may also be included in another electronic device (e.g., a summary server that provides a summary service) outside the electronic device 401. The notification management module 470 of the electronic device 401 may transmit a log and/or event information for a notification to the summary module 480 of the other electronic device using an application programming interface (API) for providing a summary service.

The notification management module 470 may obtain summary information from the summary module 480. The notification management module 470 may generate a graphic object (e.g., a summary object) corresponding to the summary information. The notification management module 470 may determine a region, corresponding to the graphic object corresponding to the summary information, of the display 460. The notification management module 470 may command the display 460 to display the graphic object in the determined region.

The display 460, according to an embodiment, may obtain the command to display the graphic object corresponding to the summary information from the notification management module 470. The display 460 may display the graphic object corresponding to the summary information in the determined region.

FIG. 5A is a flowchart illustrating an example operation of an electronic device determining a summary level based on information on a screen, according to various embodiments.

The electronic device (e.g., the electronic device 101 of FIG. 1 or the electronic device 401 of FIG. 4), according to an embodiment, may generate summary information according to a summary level. As described above with reference to FIG. 2, the summary level may refer to the degree of brevity (or the degree of detail) of the summary information that summarizes an event. The electronic device may determine the summary level among a plurality of candidate levels. The electronic device may generate summary information based on the determined summary level. The example of the summary information according to the summary level is described in greater detail below with reference to FIG. 5B.

According to an embodiment, the electronic device may determine the summary level based on information on a screen where a first input is obtained. For example, when obtaining the first input of a user while displaying a specific screen, the electronic device may determine a candidate level mapped to the specific screen to be the summary level.

Each screen may be mapped to one candidate level among the plurality of candidate levels. A screen may include at least one of a home screen, an application list screen, or a notification management screen.

The home screen may refer to a screen including an interfacing object (e.g., a widget) and/or an icon of an application designated by the user. For example, the user may designate an application that is frequently used among applications installed in the electronic device, may add an icon of the application to the home screen, and may use (e.g., execute or request the summary of an event) the application through the icon of the application displayed on the home screen. The interfacing object may be a graphic object provided by an application or a service corresponding to the application and may display, for example, information provided by the service. According to an embodiment, the home screen may include a plurality of pages. A page may be at least a portion of a screen and may refer to a region that is displayed once (e.g., at one time point) on a display of the electronic device. For example, the display of the electronic device may display one page at a time. The application list screen may refer to a screen including icons of applications installed in the electronic device. The application list screen may include a plurality of pages. The notification management screen may refer to a screen that displays a notification management window.

However, according to various embodiments of the present disclosure, each screen is not limited to being mapped to one candidate level among a plurality of candidate levels.

According to an embodiment, a first screen (e.g., the home screen) may be mapped to a candidate level, and a second screen (e.g., the application list screen) may not be mapped to any of the plurality of candidate levels at all. When the first input of the user is obtained while displaying a screen (e.g., the home screen) that is mapped to a candidate level, the electronic device may determine the candidate level that is mapped to the screen to be the summary level. When the first input of the user is obtained while displaying a screen (e.g., the application list screen) that is not mapped at all to any of the plurality of candidate levels, the electronic device may determine the summary level based on another element (e.g., at least one of a second input of the user, the number of looked-up events, or an available region of the display).

Referring to FIG. 5A, in operation 510a, the electronic device, according to an embodiment, may determine whether the screen having obtained the first input is the home screen.

In operation 520a, the electronic device may determine the summary level to a predetermined (e.g., specified) level (e.g., the candidate level mapped to the home screen), based on the screen having obtained the first input being the home screen. According to an embodiment, the predetermined level may be determined to be the lowest summary level (e.g., a summary level indicating the degree of the briefest summary). When the first input is obtained in the home screen, the electronic device may determine the summary level to the lowest summary level and may minimize and/or reduce the interference (e.g., occlusion) with another graphic object on the home screen.

Although not explicitly illustrated in FIG. 5A, the electronic device may change the summary level that is already determined based on the screen where the first input is obtained, based on the second input. For example, the electronic device may determine the summary level to the predetermined level (e.g., the lowest level), based on the screen where the first input is obtained being the home screen. The electronic device may change the summary level to a level that is designated by the second input based on the second input being obtained.

In operation 530a, the electronic device may determine the summary level based on the second input of the user, based on the screen where the first input is obtained being another screen (e.g., the application list screen or the notification management screen), not the home screen.

FIG. 5B is a diagram illustrating an example operation of obtaining a second input that designates a summary level when an electronic device obtains a first input through a notification management screen, according to various embodiments.

The electronic device (e.g., the electronic device 101 of FIG. 1 or the electronic device 401 of FIG. 4), according to an embodiment, may obtain the first input. The electronic device may display a graphic object for obtaining the second input based on information on a screen where the first input is obtained. For example, based on the screen where the first input is obtained being not the home screen, the electronic device may display the graphic object.

Referring to FIG. 5B, the electronic device may obtain the first input that designates a notification for an application through the notification management screen. The electronic device may display the graphic object for obtaining the second input through a graphic object. The graphic object may include a first region 522b corresponding to a first level and a second region 523b corresponding to a second level. The electronic device may obtain the second input of a user to one region of the first region 522b or the second region 523b of a graphic object 521b.

For example, the electronic device may determine a summary level to the first level based on a second input 524b of the user to the first region 522b being obtained in a screen 520b. For example, the electronic device may determine the summary level to the second level based on a second input 525b of the user to the second region 523b being obtained in the screen 520b.

FIG. 5C is a diagram illustrating an example operation of an electronic device generating summary information based on a summary level, according to various embodiments.

The electronic device (e.g., the electronic device 101 of FIG. 1 or the electronic device 401 of FIG. 4), according to an embodiment, may generate summary information according to a summary level.

According to an embodiment, the electronic device may determine the summary level based on a second input of a user. The second input may designate, as the summary level, one of a plurality of candidate levels.

For example, referring to FIG. 5C, the electronic device may obtain a first input 512c (e.g., a long press input) of the user to an icon 511c of an application on a screen 510c.

On a screen 520c, the electronic device may display a graphic object 521c for obtaining the second input (e.g., a second input 524c or a second input 525c) that designates the summary level, based on the first input 512c of the user being obtained. For example, referring to FIG. 5C, the plurality of candidate levels for the summary level may include a first level and a second level that is higher than the first level. The graphic object 521c may include a first region 522c corresponding to the first level and a second region 523c corresponding to the second level. The electronic device may obtain the second input of the user for one region of the first region 522c or the second region 523c of the graphic object 521c.

For example, the electronic device may obtain the second input 524c of the user to the first region 522c on the screen 520c. On a screen 530c, the electronic device may determine the summary level to the first level based on the second input 524c. The electronic device may generate summary information including a first partial text 531c and a second partial text 532c, based on the summary level that is determined to the first level. The electronic device may generate a graphic object 533c corresponding to the summary information.

For another example, the electronic device may obtain the second input 525c of the user to the second region 523c on the screen 520c. On a screen 540c, the electronic device may determine the summary level to the second level based on the second input 524c. The electronic device may generate summary information including a third partial text 541c and a fourth partial text 542c, based on the summary level that is determined to the second level. The electronic device may generate a graphic object 543c.

As illustrated in FIG. 5C, the electronic device may generate more detailed summary information for an event when the summary level is determined to be the second level compared to the first level. For example, the electronic device may generate summary information having a partial text of a greater word count when the summary level is determined to be the second level compared to the first level. Referring to FIG. 5C, the third partial text 541c may have a greater word count than the first partial text 531c. Likewise, the fourth partial text 542c may have a greater word count than the second partial text 532c.

According to an embodiment, the electronic device may determine the summary level based on the number of looked-up events in an event list. For example, the electronic device may determine a lower summary level as the number of looked-up events in the event list increases. For example, the electronic device may determine the first level as the summary level when the number of looked-up events in the event list is greater than or equal to a first number (e.g., 1) and less than or equal to a second number (e.g., 10). The electronic device may determine the second level that is less than the first level as the summary level when the number of looked-up events in the event list is greater than the second number (e.g., 10).

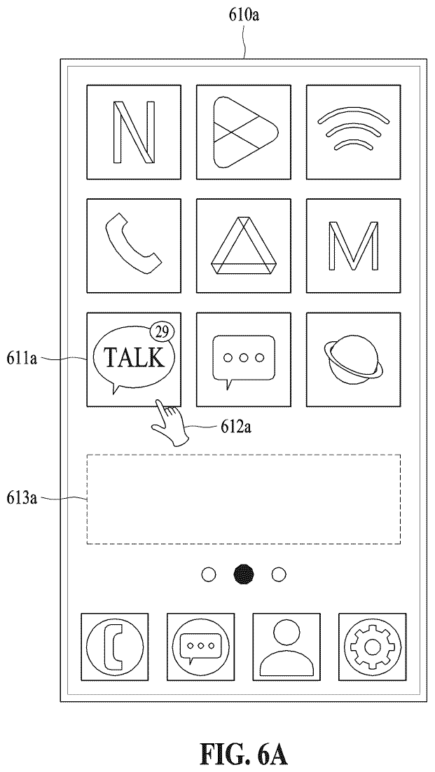

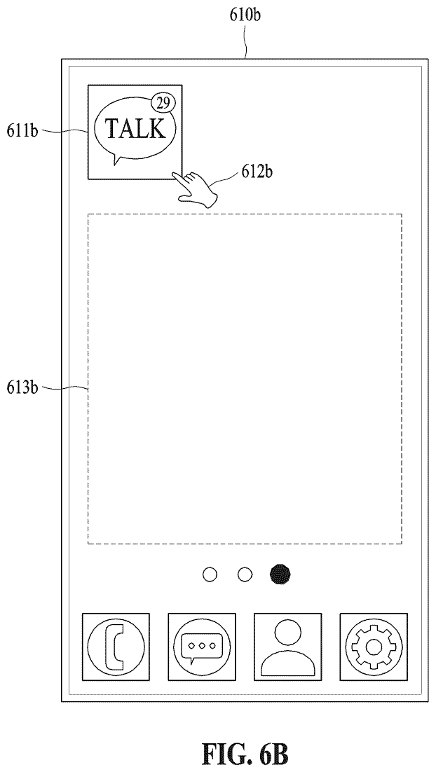

FIGS. 6A and 6B are diagrams, each illustrating an example operation of an electronic device determining a summary level based on an available region of a display, according to various embodiments.

The electronic device (e.g., the electronic device 101 of FIG. 1 or the electronic device 401 of FIG. 4), according to an embodiment, may determine an available region of the display.

The available region may refer to a region where a graphic object may be displayed. According to an embodiment, the available region of the display may include a region where a graphic object (e.g., an icon or an interfacing object) related to an application is not displayed. According to an embodiment, the available region of the display may include a region where a graphic object for which occlusion is allowed is displayed and/or a region where the graphic object is not displayed. The graphic object for which occlusion is allowed may be determined in advance according to the properties of the graphic object and/or a user's input.

The electronic device may determine a region corresponding to the inside of a polygon and/or a closed curve as the available region. The electronic device may determine a region having a predetermined shape (e.g., a rectangle, an oval, or a circle) as the available region. The electronic device may determine a region including a point having a distance that is less than or equal to a threshold from a point (e.g., an application icon) corresponding to an application as the available region. For example, the electronic device may determine a region that is adjacent to an application icon and has a rectangular shape as the available region.

The electronic device may determine a summary level based on the determined available region. For example, the electronic device may determine the summary level based on the size (e.g., an area) of the determined available region. The electronic device may determine the summary level to a first level when the area of the determined available region is greater than or equal to a first area value and less than or equal to a second area value. The electronic device may determine the summary level to a second level when the area of the determined available region is greater than the second area value.

Referring to FIG. 6A, on a screen 610a, the electronic device may obtain a first input 612a (e.g., a long press input) of the user in a region 611a corresponding to an application. The electronic device may determine a region 613a where a graphic object may be displayed, of the display (or the screen 610a), as the available region. The electronic device may determine the summary level to the first level based on the area of the region 613a being greater than the first area value and less than the second area value.

Referring to FIG. 6B, on a screen 610b, the electronic device may obtain a first input 612b (e.g., the long press input) of the user in a region 611b corresponding to an application. The electronic device may determine a region 613b where a graphic object may be displayed, of the display (or the screen 610b), as the available region. The electronic device may determine the summary level to a second level that is higher than the first level, based on the area of the region 613b being greater than the second area value.

The electronic device, according to an embodiment, may determine a summary level based on at least one of information on a screen where a first input is obtained, the number of looked-up events, or the available region of the display, and then, may obtain a second input that designates the summary level. When the summary level has been already determined when the second input is obtained, the electronic device may change the determined summary level based on the second input.

FIGS. 7A, 7B, and 7C are diagrams each illustrating an example operation of an electronic device generating summary information based on a plurality of summary forms, according to various embodiments.

The electronic device (e.g., the electronic device 101 of FIG. 1 or the electronic device 401 of FIG. 4), according to an embodiment, may generate summary information according to a summary form.

Referring to FIG. 7A, on a screen 710a, the electronic device may obtain a first input 712a (e.g., a long press input) of a user in a region 711a corresponding to a mail application. The electronic device may determine the summary form to be summarizing by events. The electronic device may look up four mail reception events (e.g., a first mail reception event, a second mail reception event, a third mail reception event, and a fourth mail reception event) in an event list for the mail application. By generating one partial text based on the event information of each mail reception event, the electronic device may generate a first partial text 713-1a, a second partial text 713-2a, a third partial text 713-3a, and a fourth partial text 713-4a.

Referring to FIG. 7B, on a screen 710b, the electronic device may obtain a first input 712b (e.g., the long press input) of the user in a region 711b corresponding to a message application. The electronic device may determine the summary form to be summarizing by event groups (e.g., event groups each including message reception events received through the same chatroom). The electronic device may look up a plurality of events in an event list for the message application. The electronic device may classify the plurality of looked-up events into five event groups based on chatrooms where messages are received. A first event group may correspond to a one-to-one chatroom with X. A second event group may correspond to a one-to-one chatroom with Y. A third event group may correspond to a one-to-one chatroom with Z. A fourth event group may correspond to a group chatroom U. A fifth event group may correspond to an anonymous chatroom V. By generating one partial text based on the event information of event(s) included in each event group, the electronic device may generate a first partial text 713-1b, a second partial text 713-2b, a third partial text 713-3b, a fourth partial text 713-4b, and a fifth partial text 713-5b.

Referring to FIG. 7C, on a screen 710c, the electronic device may obtain a first input 712c (e.g., the long press input) of the user in a region 711c corresponding to an application folder (which is named ‘messenger’ in FIG. 7C). The electronic device may determine the summary form to be summarizing by applications. The electronic device may look up events in an event list for applications (e.g., a first application, a second application, and a third application) included in the application folder. The electronic device may classify the looked-up events based on the applications. By generating one partial text based on the event information of event(s) occurring for each application, the electronic device may generate a first partial text 713-1c, a second partial text 713-2c, and a third partial text 713-3c.

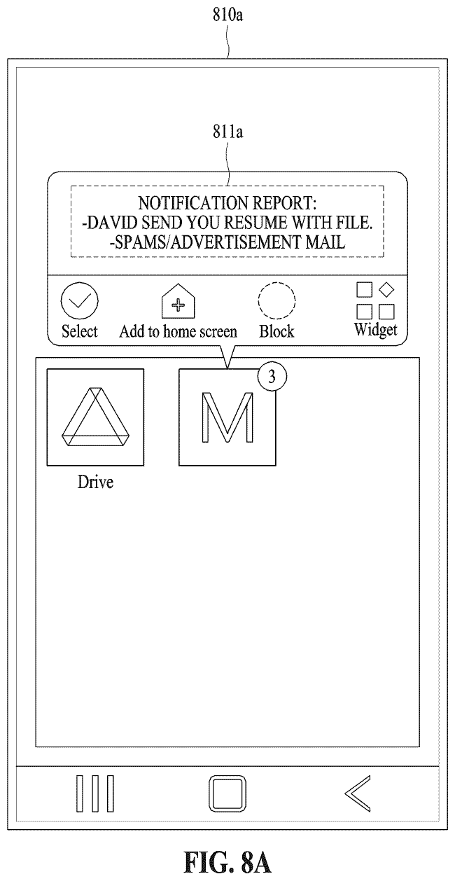

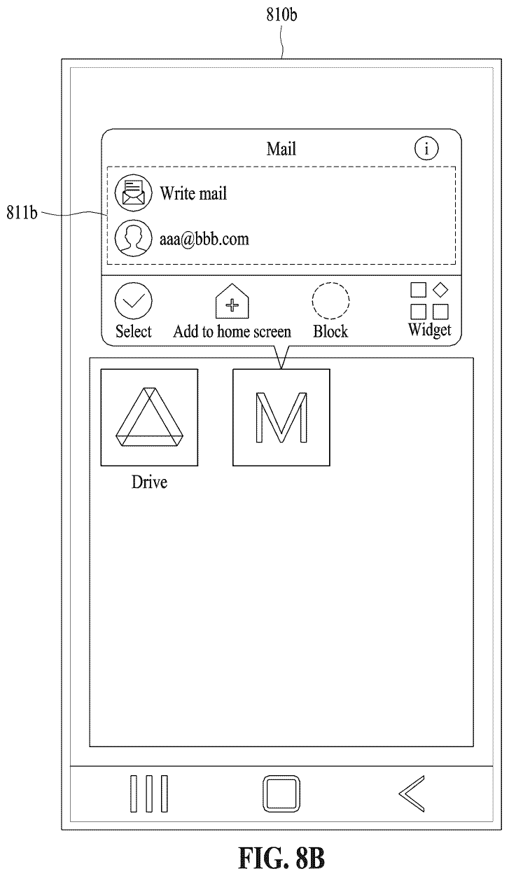

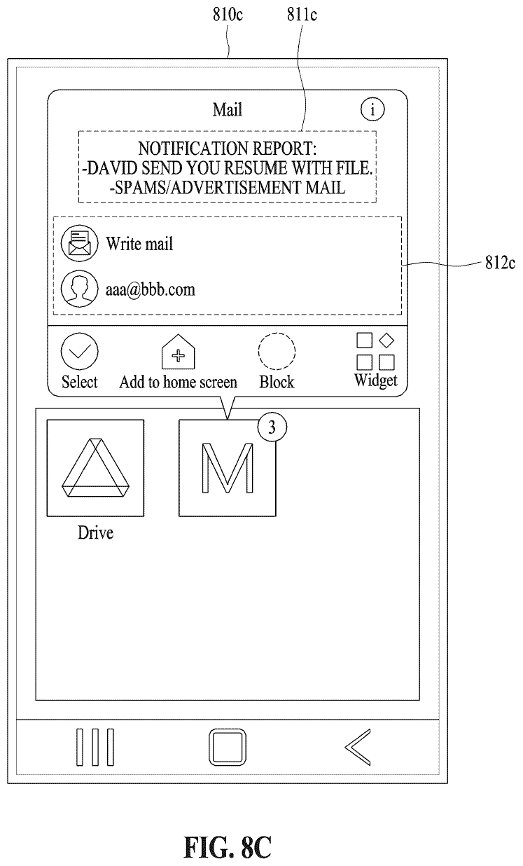

FIGS. 8A, 8B, and 8C are diagrams each illustrating an example operation of an electronic device displaying a screen based on whether an event is looked up, according to various embodiments.

The electronic device (e.g., the electronic device 101 of FIG. 1 or the electronic device 401 of FIG. 4), according to an embodiment, may determine whether to display a graphic object (e.g., a summary object) corresponding to summary information, based on whether an event is looked up in an event list for an application.

For example, the electronic device may attempt to look up events accumulated in an event list for an application when obtaining a first input (e.g., a long press input to an icon of the application) of a user to the application. Based on an event being looked up in the event list, the electronic device may generate summary information on the event and may display a graphic object corresponding to the summary information. The electronic device may display a graphic object for performing a function of the application, based on an event not being looked up in the event list.

Referring to FIG. 8A, on a screen 810a, when an event is looked up in the event list, the electronic device may display a graphic object 811a corresponding to summary information that summarizes the event.

Referring to FIG. 8B, on a screen 810b, when an event is not looked up in the event list, the electronic device may display a graphic object 811b for performing a function of an application. The graphic object 811b for a mail application may include, for example, a region corresponding to a function of writing a new mail and a region corresponding to a function of writing a new mail with a specific user account designated as a receiver.

Referring to FIG. 8C, on a screen 810c, when an event is looked up in the event list, the electronic device may display both a graphic object 811c corresponding to summary information that summarizes the event and a graphic object 812c for performing a function of an application.

The electronic device according to various embodiments disclosed herein may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic device is not limited to those described above.

It should be appreciated that embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B”, “at least one of A and B”, “at least one of A or B”, “A, B or C”, “at least one of A, B and C”, and “at least one of A, B, or C”, may include any one of, or all possible combinations of the items enumerated together in a corresponding one of the phrases. As used herein, such terms as “1st” and “2nd.” or “first” and “second” may be used to simply distinguish a corresponding component from another, and does not limit the components in other aspect (e.g., importance or order). It is to be understood that if a component (e.g., a first component) is referred to, with or without the term “operatively” or “communicatively”, as “coupled with”, “coupled to”, “connected with”, or “connected to” another component (e.g., a second component), the component may be coupled with the other component directly (e.g., by wire), wirelessly, or via a third component.

As used in connection with embodiments of the disclosure, the term “module” may include a unit implemented in hardware, software, or firmware, or any combination thereof, and may interchangeably be used with other terms, for example, “logic”, “logic block”, “part”, or “circuitry”. A module may be a single integral component, or a minimum unit or part thereof, adapted to perform one or more functions. For example, according to an embodiment, the module may be implemented in a form of an application-specific integrated circuit (ASIC).

Embodiments as set forth herein may be implemented as software (e.g., the program 140) including one or more instructions that are stored in a storage medium (e.g., an internal memory 136 or an external memory 138) that is readable by a machine (e.g., the electronic device 101). For example, a processor (e.g., the processor 120) of the machine (e.g., the electronic device 101) may invoke at least one of the one or more instructions stored in the storage medium, and execute it. This allows the machine to be operated to perform at least one function according to the at least one instruction invoked. The one or more instructions may include code generated by a compiler or code executable by an interpreter. The machine-readable storage medium may be provided in the form of a non-transitory storage medium. Here, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to embodiments of the disclosure may be included and provided in a computer program product. The computer program product may be traded as a product between a seller and a buyer. The computer program product may be distributed in the form of a machine-readable storage medium (e.g., compact disc read-only memory (CD-ROM)), or be distributed (e.g., downloaded or uploaded) online via an application store (e.g., PlayStore™), or between two user devices (e.g., smartphones) directly. If distributed online, at least part of the computer program product may be temporarily generated or at least temporarily stored in the machine-readable storage medium, such as a memory of the manufacturer's server, a server of the application store, or a relay server.

According to embodiments, each component (e.g., a module or a program) of the above-described components may include a single entity or multiple entities, and some of the multiple entities may be separately disposed in different components. According to embodiments, one or more of the above-described components or operations may be omitted, or one or more other components or operations may be added. Alternatively or additionally, a plurality of components (e.g., modules or programs) may be integrated into a single component. In such a case, according to embodiments, the integrated component may still perform one or more functions of each of the plurality of components in the same or similar manner as they are performed by a corresponding one of the plurality of components before the integration. According to embodiments, operations performed by the module, the program, or another component may be carried out sequentially, in parallel, repeatedly, or heuristically, or one or more of the operations may be executed in a different order or omitted, or one or more other operations may be added.

The units described herein may be implemented using a hardware component, a software component and/or a combination thereof. A processing device may be implemented using one or more general-purpose or special-purpose computers, such as, for example, a processor, a controller and an arithmetic logic unit (ALU), a digital signal processor (DSP), a microcomputer, a field-programmable gate array (FPGA), a programmable logic unit (PLU), a microprocessor, or any other device capable of responding to and executing instructions in a defined manner. The processing device may run an operating system (OS) and one or more software applications that run on the OS. The processing unit also may access, store, manipulate, process, and generate data in response to execution of the software. For purpose of simplicity, the description of a processing unit is used as singular; however, one skilled in the art will appreciate that a processing unit may include multiple processing elements and multiple types of processing elements. For example, the processing unit may include a plurality of processors, or a single processor and a single controller. In addition, different processing configurations are possible, such as parallel processors. The processor(s) may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described examples may be recorded in non-transitory computer-readable media including program instructions to implement various operations of the above-described examples. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random-access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

The above-described hardware devices may be configured to act as one or more software modules in order to perform the operations of the above-described examples, or vice versa.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. An electronic device comprising:
a display;
at least one processor, comprising processing circuitry; and
a memory configured to store instructions, wherein the instructions when executed by the at least one processor individually and/or collectively, cause the electronic device to:
based on a first input of a user being obtained for an application, attempt to look up events accumulated in an event list for events that are not checked by the user for the application,
based on events being looked up in the event list, generate summary information summarizing the looked-up events from event information of the looked-up events, and,
display a graphic object corresponding to the generated summary information in a region of the display corresponding to the application.

2. The electronic device of claim 1, wherein the first input comprises:
an input of the user for an icon object corresponding to the application on an application list screen or a home screen.

3. The electronic device of claim 1, wherein the instructions when executed by the at least one processor individually and/or collectively, cause the electronic device to:
determine an available region of the display, in which the graphic object is displayable,
determine a summary level based on the determined available region, and
generate the summary information based on the determined summary level.

4. The electronic device of claim 1, wherein the instructions when executed by the at least one processor individually and/or collectively, cause the electronic device to:
determine the summary level based on information on a screen where the first input is obtained, and
generate the summary information based on the determined summary level.

5. The electronic device of claim 1, wherein the instructions when executed by the at least one processor individually and/or collectively, cause the electronic device to:
determine the summary level based on the number of the looked-up events in the event list, and
generate the summary information based on the determined summary level.

6. The electronic device of claim 1, wherein the instructions when executed by the at least one processor individually and/or collectively, cause the electronic device to:
determine the summary level based on the screen where the first input is obtained,
based on a second input of the user being obtained, change the summary level to a level designated by the second input, and
generate the summary information based on the changed summary level.

7. The electronic device of claim 1, wherein the instructions when executed by the at least one processor individually and/or collectively, cause the electronic device to:
based on no event being looked up in the event list, display a graphic object for performing a function of the application.

8. The electronic device of claim 1, wherein the instructions when executed by the at least one processor individually and/or collectively, cause the electronic device to:
limit the execution of the application 146 while performing the attempting of looking up the events, the determining of the summary level, the generating of the summary information, and the displaying of the graphic object.

9. The electronic device of claim 1, wherein the instructions when executed by the at least one processor individually and/or collectively, cause the electronic device to:
based on the event occurring for the application installed in the electronic device, receive the event information from a server,
insert the event into the event list, and,
based on the user's checking of the event, delete the checked event from the event list.

10. The electronic device of claim 1, wherein the instructions when executed by the at least one processor individually and/or collectively, cause the electronic device to:
based on the first input being an input to a plurality of applications, obtain a plurality of event lists respectively for the plurality of applications,
based on events being looked up in at least one event list of the plurality of event lists respectively for the plurality of applications, determine the summary level, and
generate the summary information that summarizes the looked-up events in the plurality of event lists.

11. The electronic device of claim 1, wherein the instructions when executed by the at least one processor individually and/or collectively, cause the electronic device to:
obtain a third input of the user designating at least one summary form of summarizing by events, summarizing by groups each comprising events that are in common, or summarizing by applications, and, based on the designated summary form by the third input, generate the summary information.

12. The electronic device of claim 1, wherein the instructions when executed by the at least one processor individually and/or collectively, cause the electronic device to:
based on the properties of the looked-up events, determine at least one summary form of summarizing by events, summarizing by groups each comprising events that are in common, or summarizing by applications, and
generate the summary information based on the determined summary form.

13. A method performed by an electronic device, the method comprising:
based on a first input of a user being obtained for an application, attempting to look up events accumulated in an event list for events that are not checked by the user for the application;
based on events being looked up in the event list, generating summary information summarizing the looked-up events from event information of the looked-up events; and,
displaying a graphic object corresponding to the generated summary information in a region of the display corresponding to the application.

14. The method of claim 13, wherein the method further comprises:
determining an available region of the display, in which the graphic object is displayable; and
determining a summary level based on the determined available region land
the generating of the summary information comprises generating the summary information based on the determined summary level.

15. The method of claim 13, wherein the method further comprises determining the summary level based on information on a screen where the first input is obtained, and
the generating of the summary information comprises generating the summary information based on the determined summary level.

16. The method of claim 13, wherein the method further comprises determining the summary level based on the number of the looked-up events in the event list, and
the generating of the summary information comprises generating the summary information based on the determined summary level.

17. The method of claim 13, wherein the method further comprises:
determining the summary level based on the screen where the first input is obtained; and,
based on a second input of the user being obtained, changing the summary level to a level designated by the second input, and
the generating of the summary information comprises generating the summary information based on the changed summary level.

18. The method of claim 13, wherein the method further comprises:
based on no event being looked up in the event list, displaying a graphic object for performing a function of the application.

19. The method of claim 13, wherein the method further comprises:
limiting the execution of the application while performing the attempting of looking up the events, the determining of the summary level, the generating of the summary information, and the displaying of the graphic object.

20. A non-transitory computer-readable storage medium storing instructions that, when executed by at least one processor, cause an electronic device to perform the method of claim 13.
